(19) United States
(12) Patent Application Publication
(10) Pub. No.: US 2022/0044311 A1
(43) Pub. Date: Feb. 10, 2022

(54) METHOD FOR ENHANCING A USER'S IMAGE WHILE E-COMMERCE SHOPPING FOR THE PURPOSE OF ENHANCING THE ITEM THAT IS FOR SALE

(71) Applicant: ENVISIONBODY, LLC, Belleair Bluffs, FL (US)

(72) Inventor: Salina Dearing Ray, Belleair Bluffs, FL (US)

(21) Appl. No.: 17/393,771

(22) Filed: Aug. 4, 2021

Related U.S. Application Data
(60) Provisional application No. 63/060,892, filed on Aug. 4, 2020.

(51) Int. Cl. G06Q 30/06; G06T 19/20; G06T 19/00; G06K 7/14; G06N 20/00

(52) U.S. Cl. CPC G06Q 30/0643; G06T 19/20; G06N 20/00; G06K 7/1417; G06T 19/006

(57) ABSTRACT

One embodiment of this disclosure is a method for selling an item. The method includes providing an image to a machine, manipulating the image to provide a modified image, identifying at least one item, and displaying the at least one item on the modified image.

### FIELD OF THE INVENTION

This invention relates to a system and method for enhancing a user's image while e-commerce shopping for the purpose of enhancing the item that is for sale to increase sales and userexperiences.

### BACKGROUND

E-commerce shopping and using augmented reality try-ons has become extremely popular to conveniently purchase items for sale online. To make the experience more user friendly and effective, there are various software programs that allow a user to try on clothing before purchasing clothing items or identify proper makeup coloring based on a user's complexion among other things.

While there may be some prior art relating to e-commerce shopping in the virtual world as a user's avatar and purchasing a virtual object for their avatar, the state of the art lacks a way to manipulate a user's real time image in real life among other things. Manipulating characteristic of a user's real time image while trying on products online, in real life, will greatly enhance the display of the items on the user and promote sales. The prior art lacks disclosure of a method to enhance a body image while ecommerce shopping, to beautify and heighten the item that is displayed to the user among other things. Accordingly, the prior art fails to disclose a useful method intended to give the user a more pleasant shopping experience, bond with the brand and to increases product sales for the retailer.

U.S. Pat. Nos. 9,785,827, 10,150,025, and 10,150,026 all listing inventor Salina Dearing Ray are specifically directed towards body enhancement. However, those disclosure are related to the field of health and exercise. In those disclosures, the user is shown with less weight or more muscle mass for the purpose of exercise motivation and to assist in reaching one's fitness goals. However, these references do not allow the user to try on clothes or implement other teachings of this disclosure to enhance the user's shopping experience or provide a method for increasing sales for a retailer.

Examples of the prior art are found in U.S. Pat. Nos. 10,891,785 and 10,540,776 which describe a method of displaying a user's enhanced body image on a smart mirror that provides non-surgical body augmentation suggestions such as breast/buttock augmentations along with augmented reality view of the body enlargements or size reduction so that the user can visualize the impact of the footwear, apparel, or hairstyles when worn, along with body enhancement. However, this is used to illustrate suggestions of cosmetic surgery procedures, among other things, and show the user the effects of what the surgery performed would have on the clothing displayed to the user. Unlike the present disclosure, the prior art is not used to improve the body contour and skin complexion for the purpose of displaying the retail items to the user in the most attractive form for the purpose of increasing sales for the retailer and greatly enhancing and improving the user's shopping experience.

The prior art also includes U.S. Publication No. 2011-0078052, which is directed towards shopping in a totally virtual realty world. An online virtual reality ecommerce system provides virtual products with a user's avatar. However, this lacks the connection of real-life experience of trying on an item in real life with the convenience of using a tablet or phone for a quick view of the item on the user.

U.S. Pat. No. 7,398,133 is directed towards matching the fit of a garment. However, it is missing the ability for the user to view the product on themselves in the most attractive configuration.

Perfect Corp. provides real-time Artificial Intelligence/Augmented Reality (“AFAR”) facial detection technology utilizing facial mapping for accurate makeup renderings. Facial points are used so the technology can detect facial shapes, and movements. This allows for the makeup renderings to follow the user's face in real time as the user moves or blinks while trying on the product. However, it fails to provide the user with intuitive complexion enhancement under the makeup renderings so that the blush is slightly enhanced, for example.

Chinese Patent No. CN2891854 provides a dressing mirror with the visually beautifying function. But, to enhance the body image size, this disclosure teaches moving the hardware of the mirror. Fore example, when wanting to change the effects such as thickness of the body image, this disclosure uses a concave mirror to alter the appearance the user sees of their body shape. Although this may be effective in changing the shape of the user's reflection, it lacks the technological ability to conveniently use a mobile device and to see the retail product at the same time the enhancement is occurring.

The disadvantages that exist with prior art is that it is missing the enhanced shopping experience for the purchaser and display for the retailer. The prior art lacks the brand bonding and brand loyalty that increases sales for the retailer that is disclosed here. Additionally, producing a pleasant shopping experience for the shopper is not provided by allowing the user to see the item while looking their best. Allowing the user to view the item on themselves with a heightened sense of self confidence and pleasure is what this invention provides and is missing in existing prior art. The item is personalized to each person; allowing the user to feel a personal connection to the product and thusly brand loyalty is dramatically increased. The invention disclosed here, provides a more pleasant online shopping experience for the user and increased sales for the retailer.

### SUMMARY OF THE INVENTION

This disclosure may use image capturing, processing, and analysis software. One example of this disclosure utilizes a camera on a computer device, mixed reality and artificial intelligence processing. In this example, the user's image and movements are tracked in real time. One aspect of this disclosure considers using Apple Inc.'s ARKit's motion capture tool to allow the camera of a mobile phone to track the 3D image of the user in real time. The developer tool may be used to create a wireframe skeleton, which may be used to track motion of the most common joints, such as the knees, hips, and elbows.

Through the use of artificial intelligence and or mixed reality, an enhanced image of the user may be displayed on a screen or as a hologram that the user views of themselves while ecommerce shopping. In another aspect of this disclosure, the user's image may be provided from a still image or video of the user. For example, utilizing a QR Code Generator such as QR Code Tiger or the like, a user can scan a bar code that is embedded with the user's PNG, JPEG or video image. Using the camera on the computer device enables the bar code to be scanned and subsequently display the image. In another example, the user could upload their image from a database.

The present disclosure can be used on any computer device, including, but not limited to, a smart television, cell phone, tablet, augmented reality glasses, and/or mixed reality glasses, laptop, computer mirror, desk top computer, VR headset, or the like. The image displayed to the user may be real-time, and seen as a live video feed, still image or hologram.

In another aspect of this disclosure, a new and unique outcome of the user's enhanced appearance and more aesthetically pleasing image is achieved by image enhancing software that interfacing with the computer device. Utilizing one or more of artificial intelligence, image processing, computer vision, and machine learning that optically tracks the user body movement by using data points on the frame and joints, the user's image may be adjusted changing the contour among other things. A clothing item may then be shown on the enhanced image contour through augmented reality and/or mixed reality. The mixed reality may map and adjust to the change in the body contour and form to the new enhanced shape. Thus, displaying the item in a more appealing way. This operates in conjunction with an image enhancement algorithm for the complexion, teeth color, eye clarity, and the like.

One aspect of this disclosure is to enhance the online shopping experience for both the user and the retailer. By providing the user with an optimal self-image while shopping, the user feels a sense of confidence and connection to the brand. Simultaneously, the online retailer is able to display their product in a heightened superior way to the shopper. Thusly, substantially increasing sales.

Another example of this disclosure considers rendering eyeshadow. In this example it would be useful for the shopper and the retailer to enhance the eye clarity so that the eye shadow product rendering looked more pleasant to the user. In another example, if the user is trying on foundation, but has acne, the program would manipulate the user experience to render the foundation with the acne softened or removed. It also provides the best possible display for the makeup retailer, increasing the likelihood that the item will sell.

With the present disclosure, Augmented Reality (“AR”) and or mixed reality shopping users are now able to try on clothing, glasses, purses and bracelets virtually with upgraded technology that detects and responds to body movements and facial dimensions. Other new tools contemplated herein include voice- and gesture-controlled filters.

The advantageous use of mapping the body and joints using 3D Body Mesh tracking technology, as well as cloth simulation, which produces a clothing response as if affected by gravity, as considered herein, allows brands to produce an engaging shopping experience for the user. Combined with new technology such as voice command, which allows people to use several different voice command tools to extract existing product descriptions from a catalog, this disclosure offers an unparalleled shopping experience.

Another aspect of this disclosure considers using a hand gesture tool that allows a user to step back from their phone and see how various items would look on them by using a simple hand gesture motion to change the colors or other features.

It is clear to see that this form of shopping online will carry over to other items that a user may wish to see themselves interact with. For example, Porsche AR Visualizer is an interactive app that allows a user to select the model of vehicle they would like to see in AR form in their current environment. Once the user opens the app and selects the model that they would like to view in AR, it places the car inside their living room, for example, then they can change the color of the vehicle and try different rim options. It would be useful if the user could see themselves inside or leaning on the vehicle to personalize the experience. Our invention would allow the user to see themselves looking their best while viewing the vehicle, deepening the brand connection, and providing a pleasing experience for the user. This could also be used when purchasing household items such as furniture or larger items such as a home or boat. The present disclosure provides intuitive image enhancement adjustments to boost the shopping experience for the user and increase sales for the retailer while shopping online.

Therefore, this disclosure provides a system that benefits both the retailer of the product and the online shopper simultaneously. Utilizing image modification in substantially real-time that enhances the user's appearance while producing a display of the product in the most preeminent way. This increases sales for the retailer, strengthens brand connection to the consumer and provides the user with a more pleasant shopping experience, while boosting self-confidence. The present disclosure functions in real life, utilizing real time images of the actual user; not an avatar and the items purchased are real items that the user subsequently receives in the mail or the like.

The present disclosure can operate on ubiquitous, common devices such as a smart phone, tablet, television, smart glasses, or smart mirrors among other things. To further engage the shopper, the present disclosure contemplates using a user's Hologram to view the product on or around the Hologram while using spatial computing. For example, the user may utilize smart glasses, such as Google Glass or a VR headset. If used with a VR headset, the user may scan an image of themselves or upload their image or video from a database.

One aspect of this disclosure considers taking an image area from a current picture or generated in a real-time video, real time still image or image database, beautifying the user within the image, and displaying the augmented reality product on or around the enhanced beautified image of the user.

One embodiment is a method for selling an item that includes providing an image to a machine, manipulating the image to provide a modified image, identifying at least one item, and displaying the at least one item on the modified image.

In one example of this embodiment, the machine utilizes artificial intelligence and/or mixed reality to provide the modified real time image. In another example, the machine utilizes augmented reality to provide the real time modified image. Another example utilizes one or more of image processing, computer vision and machine learning to process user's image.

In another example, the image is uploaded to the machine from a remote location. In another example, the real time image is uploaded from another device. In yet another example, the image is captured by the machine by a camera coupled to themachine. In another example the image is an image of a user and the modified image comprises a change to at least one of the user's real time body contour, complexion, eye color and clarity, teeth brightness and alignment, smile and hair style among other things. In another example the at least one item is identified by a marker in the item. In another example, at least one item is identified utilizing artificial intelligence and/or mixed reality without utilizing a marker in the item. In yet another example, the displaying step comprises providing the at least one item on the modified image to a user display coupled to the machine. In another example, the displaying step comprises providing the modified image as a hologram. In another example, the displaying step comprises providing at least one item on the modified real time image to the user display and uploaded to the machine from a remote location. In another example, the displaying step comprises providing at least one item on the real time modified image to the user display from a remote device.

In another example, the display is produced by scanning a bar code where the user's image is embedded. In another example the displaying step comprises providing the at least one item on the modified real time image to a user display that wirelessly communicates with the machine. In yet another example, the at least one item comprises a clothing item. In another example, the at least one item comprises jewelry. In another example, at least one item comprises a watch. In another example, at least one item comprises a purse. In another example, the at least one item comprises a shoe. In another example, the at least one item comprises glasses or contacts. In another example, the at least one item comprises a vehicle. In another example, the at least one item comprises a bicycle. In another example, the at least one item comprises a motorcycle. In another example, the at least one item comprises skin care products. In another example, the at least one item comprises hair products. In another example, the at least one item comprises hair color products. In another example, the at least one item comprises exercise equipment. In yet another example, the at least one item comprises a household item. In yet another example, the at least one item comprises a technology device. In yet another example, the at least one item comprises makeup. In yet another example, the at least one item comprises real estate.

One embodiment of this disclosure is a method for selling an item. The method includes providing an image to a machine, manipulating the image to provide a modified image, identifying at least one item, and displaying the at least one item on the modified image.

In one example of this embodiment, the machine utilizes artificial intelligence and/or mixed reality to provide the modified image. In another example, the image is uploaded to the machine from a remote location, such as the a cloud database. In yet another example, the image is uploaded to the machine from a remote device. In yet another example, the image is captured by the machine through a camera coupled to the machine. In another example, the image is uploaded from a database. In yet another example, the image is uploaded from a bar code. In another example, the image is one of a still image, real time image or a video image. In another example, the image is a real time image of a user and the modified image comprises a change to at least one of the user's body contour, skin complexion, eye color, eye clarity, teeth alignment and color, smile, and hair. In yet another example, the at least one item is identified by a marker in or on the item. In another example, the at least one item is identified utilizing artificial intelligence and or mixed realty without utilizing a marker in the item. In yet another example, the displaying step comprises displaying the at least one item on the modified image with a user display coupled to the machine. In another example, the displaying step comprises displaying the at least one item on the modified image to a remote user display from a remote machine. In yet another example, the displaying step comprises displaying the at least one item on the modified image with a personal computing device that wirelessly communicates with the machine. In yet another example, the at least one item comprises a clothing item. In another example, the at least one item comprises jewelry. In yet another example, the at least one item comprises makeup. In another example, the at least one item comprises one or more of shoes, a purse, glasses, contacts, a vehicle, exercise equipment, a technology product, a household item, real estate, a bicycle, a skin care product, or artificial nails.

Another embodiment of the present disclosure is a method for selling an item. The method includes providing an image of a user to a machine, manipulating the image to provide a modified image of the user having enhanced physical features, identifying at least one item through a user input, and displaying the at least one item on the modified image having the enhanced physical features of the user.

In one example of this embodiment, the enhanced physical features are one or more of modifications to the user's frame, complexion, eye, hair color, hair style, smile, teeth color, and teeth alignment and the at least one item comprises one or more of shoes, a purse, glasses, contacts, a vehicle, exercise equipment, a technology product, a household item, real estate, a bicycle, a skin care product, or artificial nails.

### DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is an exemplary flow chart of the present disclosure; and

FIG. 2 is a schematic representation of components of the present disclosure.

Other features and advantages of the present invention will become apparent from the following more detailed description, taken in conjunction with the accompanying drawings, which illustrate, by way of example, the principles of the invention.

### DETAILED DESCRIPTION

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

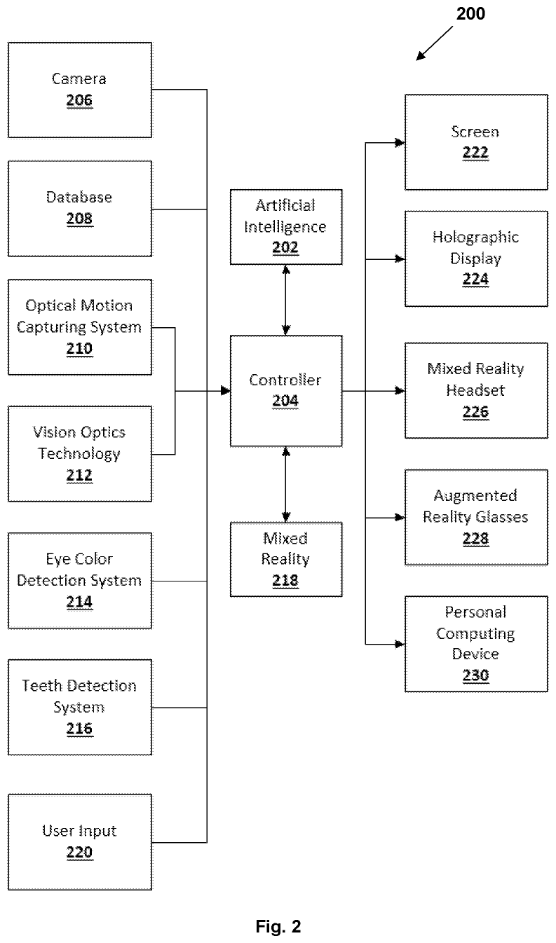

Referring to FIG. 2, one exemplary schematic machine 200 is illustrated. The machine 200 may have a controller 204 that control the processing of information provided to, and sent from, the controller 204. The controller 204 may have one or more processor and access to a memory unit. In one example, the controller 204 is part of a computing system that has inputs and outputs that can execute the methods discussed herein

The controller 204 may implement an artificial intelligence (“AI”) protocol 202 as part of this disclosure. The AI protocol 202 may utilize machine learning and historical user data to automatically generate recommendations and modifications for the present disclosure. Further, the controller 204 may also utilize mixed reality 218 to provide outputs to a user that show a modified real-time image or a previously uploaded image with altered image data.

The controller 204 may also communicate with a camera 206, database 208, optical motion capturing system 210, eye color detection system 214, user input 220, screen 222, holographic display 224, mixed reality headset 226, augmented reality glasses 228, and personal computing device 230 among other things. The controller 204 may communicate with these devices through any known wired or wireless protocol. In one aspect of this disclosure, one or more of these components may be part of the same physical hardware component. Alternatively, different components discussed herein may be separate hardware components that communicate with the controller 204. Regardless, the controller 204 may communicate with one or more of the devices and systems discussed herein to implement the teachings of this disclosure.

In one aspect of this disclosure, the machine 200 has the camera coupled thereto. The camera 206 can take video or photographic images of the user or other surroundings to be further processed by the controller 204. In one aspect of this disclosure, photographs and videos taken by the camera 206 may be stored in the database 208 to be selectively processed by the controller 204 at a later time. The camera 206 may also provide photographic or video data to be processed as part of the optical motion capturing system 210, the vision optics technology 212, the eye color detection system 214, or the teeth detection system 216. In other words, the controller 204 may selectively use information provided from the camera 206 to implement one or more of the systems or technologies discussed herein 210, 212, 214, 216.

The controller 204 may also communicate with a user input 220. The user input 220 may be a part of the machine 200 that allows a user to input data, such as a keyboard, touchscreen, or any other user input device. The user input may be from devices or displays such as augmented reality glasses 228, mixed reality headset 226, Holographic display 224 and or screen 222. Alternatively, the user input 220 may be part of an application that can be sent to the controller 204 from a personal computing device 230 such as a smart phone, tablet, personal computer, or any known device commonly used for personal data management. Alternatively, the controller 204 may receive the user's input 220 automatically utilizing the camera 206 and artificial intelligence 202.

The machine 200 may also have the screen 222 coupled thereto as part of a single hardware component. Alternatively, the screen 222 may be locate remotely from the remaining components of the machine 200. In one aspect of this disclosure, the screen 222 may be displayed on the personal computing device 230. Alternatively, the screen 222 may be positioned at any strategic location separate from the remaining components of the machine 200.

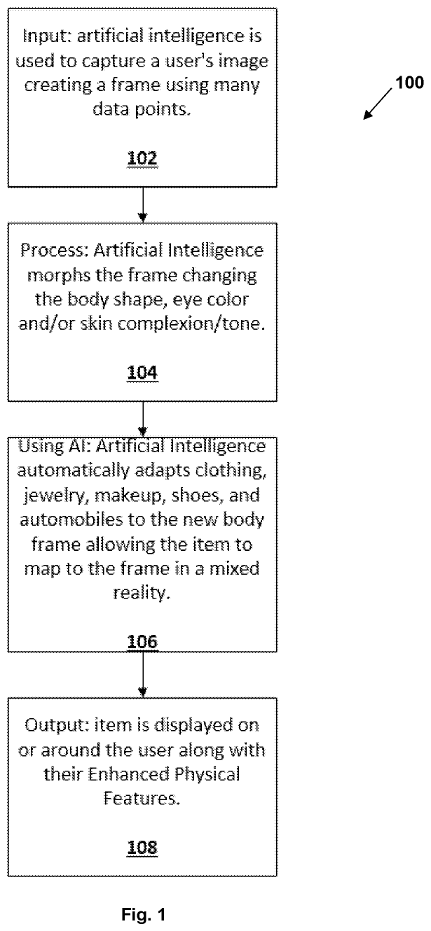

Referring now to FIG. 1, an exemplary flow chart 100 of present disclosure is illustrated. This flow chart 100 may initiate in box 102 by utilizing a machine 200 having artificial intelligence 202 or the like implemented by a controller 204 having a memory unit and one or more processors to capture a user's image and detect data points on a user's frame. The artificial intelligence 202 may have access to a camera 206 or the like or real time images of the user may be gathered from a database 208 or manually or automatically uploaded to the artificial intelligence 202 for further analysis. In one example, Apple's ARKit or a similar program could be used for body tracking and motion capture. The body tracking and motion captures may use data points that track the joints of a human skeleton. In one non-limiting example, a marker-based (or markerless) feedback optical motion capturing system 210 may extract the user's skeleton frame using the user's image. The image captured may be from a still image captured by the camera 206 or from still images uploaded to the machine 200, from a live video stream or a database of similar images. The user's skeleton may be extracted using any method know in the art and some non-exclusive examples include OpenPose engine and Kinect-based markerless systems. However, any known system that can analyze an image is considered herein.

In one aspect of this disclosure, skin color and/or tone (or “complexion”) may also be detected in box 102. In one non-exclusive example, the user's complexion may be detected utilizing Vision Optics Technology 212 to detect and analyze details of the user's complexion and skintone. One non-exclusive example of Vision Optics Technology 212 is Foundation Finder by Maybelline. However, any known software capable of identifying a user's complexion is considered herein.

Also part ofbox 102 may be an eye color detection system 214. The eye color detection system 214 may automatically extract the iris region of the user based on the image. The extracted iris region may be further analyzed and a color classification may be performed. The color classification may utilize a Gaussian Mixture Model and a jointly employed system on a UBIRIS2 database and provide results. The classified eye color may be used as a soft biometric by the artificial intelligence 202 to identify another aspect of the user. See, as one non-exclusive example, “On the reliability of eye color as a soft biometric trait” by Antitza Dantcheva, Jean-Luc Dugelay, Sophia Antipolisand Nesli Erdogmus, the contents of which are hereby incorporated herein by reference.

Also part of box 102 may be a teeth whitening and alignment detection system 216. The teeth detection system 216 may automatically extract the teeth of the user based on the real time image. The extracted teeth region may be further analyzed and an enhancement in brightness or alignment may be performed. The teeth enhancement my utilize a program like Fotor editing technologies to enhance the color of the teeth. The artificial intelligence 202 may utilize any one or more of these traits to further analyze the user.

In box 104, the frame, complexion, eye, hair color and style, smile, and/or teeth data (collectively “Physical Features Data”) may then be processed through an artificial intelligence application 202 in real time to manipulate the Physical Features Data. The artificial intelligence application 202 may manipulate the user's real time image body contour and/or one or more other of the Physical Features Data to create Enhanced Physical Features wherein modifications are made to the Physical Features Data. In other words the camera 206 may take the user's real time image as input into the artificial intelligence 202 and manipulate the user's image to change any physical trait of the user via the Physical Features Data. The artificial intelligence 202 and mixed reality application 218 may be any known image manipulation software that is capable of altering the image as discussed herein.

In box 106, markers are identified on the user. The markers are associated with various personal items that the user is interfacing with and may be anchored to the user's new real time digital frame or image established in box 104. In another embodiment, artificial intelligence 202 and mixed reality 218 may be implemented to allow markerless products to automatically anchor in real time to the modified user's image from box 106. The process of anchoring the user's frame may be achieved utilizing a program like Microsoft special awareness and surface magnetism which makes any object snap to the surface. In this embodiment, the updated user's image from box 104 may provide real time Enhanced Physical Features to allow the artificial intelligence 202 and mixed reality 218 to map the Enhanced Physical Features of the user's real time image and display it accordingly. In another embodiment, the user's updated image from box 104 may provide real time Enhanced Physical Features to allow the artificial intelligence 202 to map the Enhanced Physical Features of the user's real time image and display accordingly in box 108.

In box 108, the user may utilize a user input to select an item to be displayed on a screen 222. The screen 222 may be a Holographic display 224. In another embodiment contemplated herein the item identified by the real time user or the artificial intelligence 202 may be displayed through a Holographic display 224. In another example, the item identified by the user or the artificial intelligence 202 may be seen on a mixed reality headset 226 such as Facebook Oculus or Microsoft HoloLens, in order to produce the real world Holographic display. In yet another embodiment, augmented reality glasses 228 (also known as “smart glasses”) such as Google Glasses and Snap Spectacles may be used to see the real time enhanced image with the example of the item selected by the user. In another example, the item identified by the user or the artificial intelligence 202 may be displayed on a personal computing device 230 such as a smart phone, tablet, desktop computer, laptop, or television.

In one aspect of this disclosure, the item is adjusted to the modified real time user's image from box 104, which may contain the Physical Enhancements. The modified user's image may be updated in real time. Accordingly, in box 108 the item may be displayed on the modified user's image in real time to illustrate the item on/around the user with the Physical Enhancements. In one aspect of this disclosure, the method discussed herein may create a more pleasant shopping experience for the user along with providing a method for the retailer to increase sales by allowing the user to see the item as it would appear on a modified real time user image.

While a particular form of the invention has been illustrated and described, it will be apparent that various modifications can be made without departing from the spirit and scope of the invention. For example, the system may be adapted to be used for a group of people, such as a yoga or exercise class. Alternately, the system may be adapted for use by people who are not exercising on an exercising machine or ecommerce shopping. For example, mental health patients might use the system to assist in positive self-imagery such as a smile, self-esteem and autonomy exercises. In another example, a cosmetic surgeon or beauty treatment centers may want to show their client what they would look like in cloths in real time while in the office visit, after body contouring procedures. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. In addition, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A method for selling an item, comprising:
providing an image to a machine;
manipulating the image to provide a modified image;
identifying at least one item; and
displaying the at least one item on the modified image.

2. The method of claim 1, wherein the machine utilizes artificial intelligence to provide the modified image.

3. The method of claim 1, wherein the image is uploaded to the machine from a remote location.

4. The method of claim 1, wherein the image is uploaded to the machine from a remote device.

5. The method of claim 1, wherein the image is captured by the machine through a camera coupled to the machine.

6. The method of claim 1, wherein the image is uploaded from a database.

7. The method of claim 1, wherein the image is uploaded from a bar code.

8. The method of claim 1, wherein the image is one of a still image, real time image or a video image.

9. The method of claim 1, wherein the image is a real time image of a user and the modified image comprises a change to at least one of the user's body contour, skin complexion, eye color, eye clarity, teeth alignment and color, smile, and hair.

10. The method of claim 1, wherein the at least one item is identified by a marker in or on the item.

11. The method of claim 1, wherein the at least one item is identified utilizing artificial intelligence without utilizing a marker.

12. The method of claim 1, wherein the displaying step comprises displaying the at least one item on the modified image with a user display coupled to the machine.

13. The method of claim 1, wherein the displaying step comprises displaying the at least one item on the modified image to a remote user display from a remote machine.

14. The method of claim 1, wherein the displaying step comprises displaying the at least one item on the modified image with a personal computing device that wirelessly communicates with the machine.

15. The method of claim 1, wherein the at least one item comprises a clothing item.

16. The method of claim 1, wherein the machine utilizes mixed reality to provide the modified image.

17. The method of claim 1, wherein the at least one item comprises makeup.

18. The method of claim 1, wherein the at least one item comprises one or more of shoes, jewelry, a purse, glasses, contacts, a vehicle, exercise equipment, a technology product, a household item, real estate, a bicycle, a skin care product, or artificial nails.

19. A method for selling an item, comprising:
providing an image of a user to a machine;
manipulating the image to provide a modified image of the user having enhanced physical features;
identifying at least one item through a user input; and
displaying the at least one item on the modified image having the enhanced physical features of the user.

20. The method of claim 19, further wherein the enhanced physical features are one or more of modifications to the user's frame, complexion, eye, hair color, hair style, smile, teeth color, and teeth alignment and the at least one item comprises one or more of shoes, a purse, glasses, contacts, a vehicle, exercise equipment, a technology product, a household item, real estate, a bicycle, a skin care product, or artificial nails.
